(19) United States
(12) Patent Application Publication
(10) Pub. No.: US 2024/0289811 A1
(43) Pub. Date: Aug. 29, 2024

(54) SYSTEM AND METHOD TO OPTIMIZE THIRD PARTY CRM IMPLEMENTATIONS

(71) Applicant: Vortac, LLC, Gridley, IL (US)

(72) Inventor: Ryan Fedell, Novi, MI (US)

(21) Appl. No.: 18/113,745

(22) Filed: Feb. 24, 2023

(51) Int. Cl. G06Q 30/01; G06Q 10/10

(52) U.S. Cl. CPC G06Q 30/01; G06Q 10/10

(57) ABSTRACT

Disclosed herein are a system and method for creating third party Customer Relationship Manager (CRM) software applications including a customized graphical user interface (GUI) to manage interactions between a business and its customers and/or prospects. The system comprises a response database system storing historical responses of businesses to questions regarding its business, fields to use in its GUI and placement of fields in the GUI. A usage database system stores actual usage data from ongoing third party CRM software applications. A software user interface operates on one or more user processing systems which is operative to present questions to a business user regarding its business, fields to use in the GUI and placement of fields in the GUI. A server system is in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields. The server system is programmed to communicate with the software user interface to present the recommendations to the business user and to respond to approval of the business user to the recommendations, configuring the CRM software application comprising the customized GUI and creating Application Programming Interface (API) connections that interact and sync the customized GUI with API layers in the business users CRM software.

### CROSS-REFERENCE TO RELATED APPLICATIONS

There are no related applications.

### FIELD OF THE INVENTION

This invention relates to implementation of third party business Customer Relationship Management software and, more particularly, to creating a customized graphical user interface to manage interactions between a business and its customers and/or prospects.

### BACKGROUND OF THE INVENTION

Customer Relationship Management, or CRM, software as it is commonly called, is a business software that is used to manage the interactions a business has with their prospects and customers. CRM software is used to track information about accounts and contacts, quotes, tasks, calendar events, and many other business related topics that inform a business about who they have been communicating with, what they have been communicating about, and when those communications took place. CRM software can be used by any business to help their marketing, sales, operations, and support teams to provide a more personalized and better service for their customers.

CRM technologies offer the promise of more streamlined operations for the businesses that use them. CRM software can keep their data organized, help them find new customers, automates tasks, resolve business issues, provide reporting on key business information, and much more. Most companies that purchase CRM software need to configure or develop their CRM application so that it will work for their unique business needs.

CRM software setup varies drastically from vendor to vendor. In almost every case the documentation is overwhelming. Some CRM vendors have tens of thousands of knowledge base articles, “how-to” tutorials scattered across the internet and many other third-party generated content regarding implementation. On top of the technical requirements, business domain expertise is needed to properly design systems, processes, and other technical aspects to make the implementation successful. In many cases technical consultants are required to partially or completely design, implement and deploy a CRM software project. Each CRM software package has their own database with “backend” setup menus or developer/sandbox environments for businesses or consultants to work in. These developer environments use many different methods to deploy customizations, including the use of writing software code. The options for configuration are nearly unlimited and are difficult for even experienced technologists to work with.

As a result, as many as 50-70% of CRM implementations fail, and have been failing at this rate for the past 25 years, even when highly experienced technical consultants are involved. This leaves a business with a CRM configuration that is set up poorly, which at best makes the system confusing, and at worst, makes the system unusable. The current process is so complicated, error prone, and resource intensive that high project failure rates will continue indefinitely into the future if something doesn't change.

The present invention is directed to improvements in implementation of third party CRM software.

### SUMMARY OF THE INVENTION

In one aspect of the invention, a computer implemented method of creating third party Customer Relationship Manager (CRM) software applications includes a customized graphical user interface (GUI) to manage interactions between a business and its customers and/or prospects. The method comprises: providing a response database system storing historical responses of businesses to questions regarding its business, fields to use in its GUI and placement of fields in the GUI; providing a software user interface operating on one or more user processing systems which is operative to present questions to a business user regarding its business, fields to use in the GUI and placement of fields in the GUI; providing a server system in operative communication with the response database system and the software user interface and operating CRM implementation software comprising a software prediction engine, the software prediction engine being operative to control the software user interface to present questions to the business user and to store current responses in the response database system, the software prediction engine automatically compares current responses to historical responses to recommend what fields to use in the GUI, when in the process such fields should appear and where in the GUI to display the fields; the server system communicating with the software user interface to present the recommendations to the business user; and responsive to approval of the business user to the recommendations, the server system configures the CRM software application comprising the customized GUI and creating Application Programming Interface (API) connections that interact and sync the customized GUI with API layers in the business users CRM software.

It is a feature that the server system controls the software user interface to presents additional questions to the business user responsive to the current responses and to store further current responses in the response database system.

It is another feature that the server system controls the software user interface to continually present additional questions to the business user until all needed questions have been responded to.

It is a further feature that the software prediction engine comprises software algorithms looking for patterns and trends related to fields, business processes, and digital placement of fields on the GUI.

It is an additional feature that the server system is in operative communication with processing systems using business users CRM software and the server system receives actual usage data from ongoing implementations of CRM software applications to continually monitor and score the effectiveness of the implementations. A usage database system may store the actual usage data.

It is a feature that the software prediction engine is operative to automatically compares current responses to historical responses and to actual usage data to recommend what fields to use in the GUI, when in the process such fields should appear and where in the GUI to display the fields. The software prediction engine may continually update questions to present to the business user responsive to actual usage data.

It is a further feature that the CRM implementation software continually monitors and score effectiveness of ongoing CRM software applications to improve predictions and recommendations.

It is still another feature that the CRM implementation software continually determines if scores are higher or lower than expected and updates the accuracy and precision of its predictions for future recommendations and updates and creates new algorithms based the scoring and actual usage data to improve responses and recommendations.

In accordance with another aspect of the invention, a computer implemented method of creating third party Customer Relationship Manager (CRM) software applications includes a customized graphical user interface (GUI) to manage interactions between a business and its customers and/or prospects. The method comprising: providing a response database system storing historical responses of businesses to questions regarding its business, fields to use in its GUI and placement of fields in the GUI; providing a usage database system storing actual usage data from ongoing third party CRM software applications; providing a software user interface operating on one or more user processing systems which is operative to present questions to a business user regarding its business, fields to use in the GUI and placement of fields in the GUI; providing a server system in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields; the server system communicating with the software user interface to present the recommendations to the business user; and responsive to approval of the business user to the recommendations, the server system configures the CRM software application comprising the customized GUI and creating Application Programming Interface (API) connections that interact and sync the customized GUI with API layers in the business users CRM software.

There is disclosed in accordance with another aspect a system for creating third party Customer Relationship Manager (CRM) software applications including a customized graphical user interface (GUI) to manage interactions between a business and its customers and/or prospects. The system comprises a response database system storing historical responses of businesses to questions regarding its business, fields to use in its GUI and placement of fields in the GUI. A usage database system stores actual usage data from ongoing third party CRM software applications. A software user interface operates on one or more user processing systems which is operative to present questions to a business user regarding its business, fields to use in the GUI and placement of fields in the GUI. A server system is in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields. The server system is programmed to communicate with the software user interface to present the recommendations to the business user and to respond to approval of the business user to the recommendations, configuring the CRM software application comprising the customized GUI and creating Application Programming Interface (API) connections that interact and sync the customized GUI with API layers in the business users CRM software.

Further features will be readily apparent from the specification and the drawings.

### BRIEF DESCRIPTION OF THE DRAWINGS

FIG. 1 is an overview flow diagram illustrating user interactions with the methodology to optimize third party CRM implementations including a customized graphical user interface (GUI) to manage interactions between a business and its customers and/or prospects in accordance with the invention;

FIG. 2 is a hardware block diagram illustrating an exemplary system for implementing the methodology of FIG. 1;

FIG. 3 is a flow diagram illustrating computer software for implementing the methodology of FIG. 1;

FIGS. 4-11 are illustrations of interactive screen displays for a software user interface generated by the software of FIG. 3;

FIG. 12 illustrates Application Programming Interface connections created by the software of FIG. 3;

FIG. 13 illustrates an audit communicated to a business user as part of deployment of the CRM software application GUI in accordance with the invention;

FIG. 14 is a flow diagram illustrating deployment of the CRM software application GUI for use with a business user's CRM software; and

FIG. 15 is a flow diagram illustrating software for monitoring usage of business users' CRM software.

### DETAILED DESCRIPTION OF THE PREFERRED EMBODIMENT

Described herein is a CRM implementation software package that improves the ability for a 3rd party business' Customer Relationship Management (CRM) software application to be implemented for its business. The described CRM implementation software does all of the custom processing in its software and generates a software output that can be used by the 3rd party CRM to improve their software's setup capabilities. In addition, CRM implementation software analyzes usage data from the business' 3rd party CRM software and uses that feedback to improve the recommendations, in terms of possibilities, as well as accuracy, making the CRM implementation software an increasingly valuable and intelligent machine. Each iteration of feedback allows the described CRM implementation software to learn and improve, drawing conclusions from a vast array of CRM data.

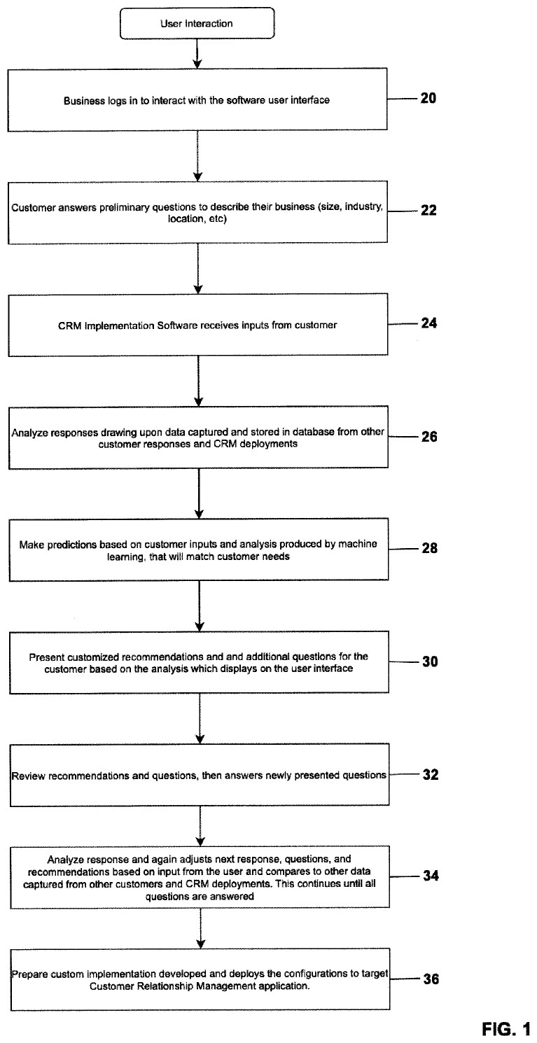

An overview of user interactions with the CRM implementation software is shown in FIG. 1.

The CRM implementation software is a software platform operating on a server system that interacts with business customers wanting to implement a custom CRM for their business. Through different software layers that will be described below, the CRM implementation software expertly guides businesses to a customized CRM implementation via Artificial Intelligence (AI) and Machine Learning.

The process begins at 20 where a business signs up to use the CRM implementation software. The business interacts with the CRM implementation system using a software user interface where they are presented with questions and images. The business starts the process by providing information about its business that is requested by the CRM implementation software at 22.

The CRM implementation software receives responses at 24, and at 26 analyzes their responses against databases of other business responses. As the CRM implementation software processes and algorithms run, CRM implementation software asks additional questions, makes predictions, and offers recommendations to the business regarding functionality and options they may want to include in their CRM at 28 and 30.

The business interacts with the CRM implementation software by answering additional questions and accepts or rejects recommendations. As a business answers questions and accepts or rejects recommendations, the CRM implementation software process analyzes results and makes new predictions, and creates new questions and recommendations in response, always drawing upon the business' responses as well as the database of other business customers results (including answered questions and accepted and rejected recommendations from those other businesses) at 32.

The business can “chat” with the CRM implementation software to ask any questions they have during the process, related to the questions that CRM implementation software asks in that sequence or any other questions. The CRM implementation software will respond after searching the database and provide an answer.

This process continues at 34 until all questions have been answered by the business, and at this point the implementation is ready for deployment.

The CRM implementation software prepares to create a software package output that will be used by the 3rd party business CRM to accept the custom configurations developed by the CRM implementation software. The software is delivered to the 3rd party CRM via API (Application Programming Interface) connections at 36. When the implementation is completed, the business can then use their custom configured 3rd party CRM software.

As the business uses their CRM software, the CRM implementation software will continue to analyze and receive data about the CRM usage and effectiveness. This feedback and additional processing will strengthen the CRM implementation software's understanding of its predictions and refine its ability to ask better questions and make better recommendations for future CRM implementation software businesses.

As described in greater detail below, the CRM implementation software is a software application that uses machine learning to optimize 3rd Party CRM software. The CRM implementation software analyzes data in order to make predictions about the next best recommendation for a new business customers implementation including fields, business process, and digital placement of fields on the CRM software graphic user interface (GUI). This data is compiled from three sources: 1) The current business who is using the CRM implementation software to implement their CRM software; 2) Implementations created by CRM implementation software for previous business and the responses they gave about their business; and 3) data from 3rd party CRMs being used in production (in other words, after a business has already completed their CRM implementation and they start using their CRM software). When CRM data is received and analyzed, the CRM implementation software algorithms are looking for patterns and trends related to fields, business processes, and digital placement of fields on the GUI. The trained algorithm is already familiar with fields, business processes, and digital placement of fields and has an existing effectiveness score that will be confirmed or updated following each analysis.

The algorithm is continually evaluating these three sources of data to refine its predictions about what fields to suggest, when in the business process the field should appear, and where on the user interface the field should be displayed, to maximize the value of the CRM software for the business. The recommendations are then presented to the business using the CRM implementation software interface where the business then accepts or rejects the recommendations while they are going through the implementation process. When the implementation process is completed, the CRM implementation software generates software that can be deployed to the 3rd party CRM software via APIs. The techniques used to deploy the implementation are not only more effective for the business because of the CRM implementation software “prediction engine”, but also more efficient for the 3rd party CRM to consume, because the method is reducing the load and processing time on their servers, compared to deploying their CRM software through their own default methods. As a result of the disclosed process, the CRM implementation software is analyzing digital instructions and computer code from many disparate sources and making unique recommendations for each business doing a custom CRM implementation.

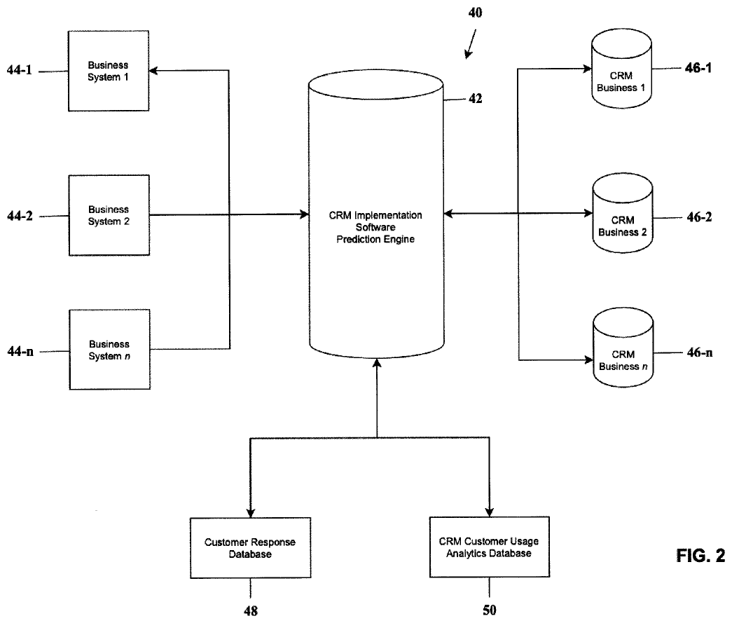

An exemplary system 40 for implementing the CRM implementation process is illustrated in FIG. 2.

A server system 42 is programmed to implement CRM implementation software in accordance with the invention. The server system 42 comprises any necessary or desired processors, memory devices, peripherals and the like. The server system 42 is in operative communication, such as via the Internet, with plural business implementation systems 44-1, 44-2 and 44-n, referenced generically as 44. Each business implementation system 44 comprises any necessary or desired processors, memory devices, peripherals and the like. Each business implementation system 44 operates using a software user interface generated by the server system 42, as described and shown below, to present questions to a business user regarding its business, fields to use in the GUI for its CRM software applications and placement of fields in the GUI. The server system 42 is in operative communication, such as via the Internet, with plural business CRM systems 46-1, 46-2 and 46-n, referenced generically as 46. Each business CRM system 46 comprises any necessary or desired processors, memory devices, peripherals and the like. Each business CRM system 46 is operative to operate the business' CRM application software so that the business can keep their data organized, help them find new businesses, automates tasks, resolve business issues, provide reporting on key business information, and more.

As will be apparent, any business' implementation system 44 and its corresponding CRM system 46 may use the same hardware, as necessary or desired.

The server system 42 communicates with a response database system 48 storing historical responses of businesses to questions regarding its business, fields to use in its GUI and placement of fields in the GUI. This represents the data warehouse for business-provided responses, which the CRM implementation software algorithms will draw upon to conduct analysis and make predictions. The server system 42 communicates with a usage database system 50 storing actual usage data from ongoing third party CRM software applications operating on the business CRM systems 46. This represents the data warehouse for CRM data provided from business CRM software applications, which the CRM implementation software algorithms will draw upon to conduct analysis and make predictions.

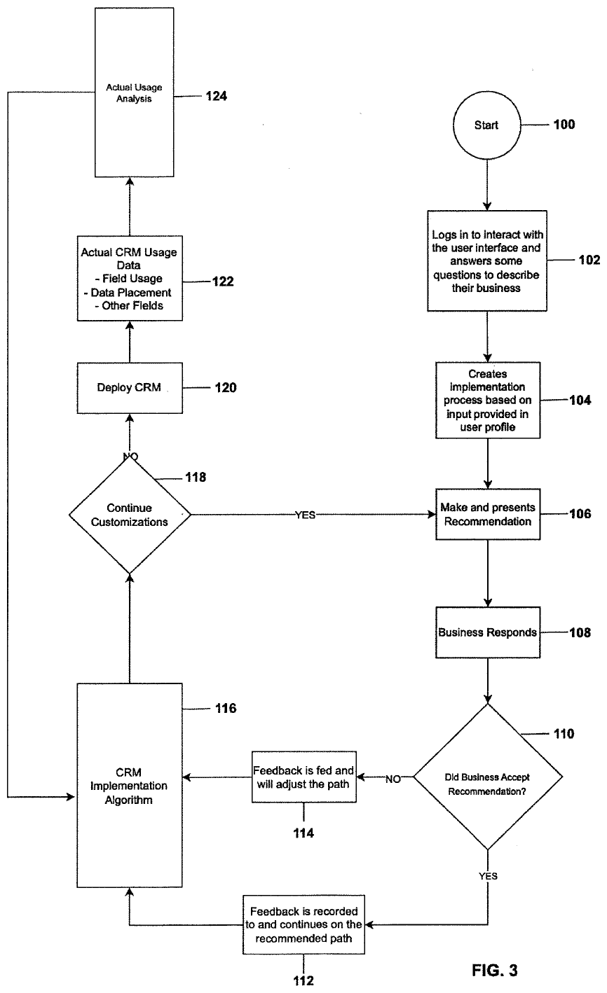

Each business implementation system 44 represents a unique business customer with a unique user account in CRM implementation software. As each business is interfacing with CRM implementation software, the responses are analyzed by CRM implementation software, discussed below relative to FIG. 3, which will run statistical analysis of each response, and the algorithm will create patterns based on these responses. The algorithm will draw upon the business' industry, organizational size, CRM elements being configured, the business' stated goals and outcomes, all past responses, as well as scoring responses as likely or unlikely based on other responses and actual data usage from the business' CRMs. Scores, results, and recommendations are then stored in the response database 48.

The server system 42 operates the CRM implementation software algorithms. The CRM implementation software uses structured and unstructured machine learning to improve the CRM implementation software's implementation process. The following serves as an example of how the algorithm works: 1) CRM implementation software presents 3 questions to the business asking their industry, business size, and business specialty. 2) The business responds with its input. 3) CRM implementation software reviews response and reviews data submitted by previous businesses and learns which are most effective to start the process. 4) The algorithm measures all questions asked by frequency as well as whether those questions lead to positive or negative responses, giving each question an effectiveness score. 5) The algorithm analyzes the sequence of the questions and begins to order the questions in optimal ways. 6) Each new response from the business makes future questions statistically more or less likely based on their effectiveness score. 7) The CRM implementation software code is looking for more similarities and patterns that emerge as each question is answered by the business, and the AI better understands who the business is, anticipating their needs based on effectiveness scores that are updated in real-time. 8) Businesses with similarities will be reviewed, and next best questions will emerge as a result of analyzing those patterns and similarities. 9) Scores are updated as the new business responds to the suggestions. 10) Similarities and differences are recorded and stored for future analysis. 11) New patterns will be identified by the AI as more businesses are using CRM implementation software, allowing previously unknown conclusions to be made. 12) Values are continually updated and/or created based on business input and CRM data being evaluated. 13) Data analysis is also continually being performed based on actual usage from businesses CRMs using data in the usage database 50. This data is processed in real time and recalculates the effectiveness scores for suggestions to be made in the future. 14) As the AI becomes more intelligent, the system will make predictions and suggestions that CRM implementation software has taught itself to ask (such as recognizing patterns emerging from other similar industries or company sizes, geographies, etc). 15) This pattern recognition is happening in real time, and increasingly the accuracy of predictions are leading toward more valuable implementations for the business. 16) CRM implementation software algorithm will process and identify the next best question to ask the business based on the analysis and then present that question on the user interface.

Each business CRM system 46 represents a unique businesses CRM software application running on the business' processing systems. Each CRM is sharing actual data usage with CRM implementation software. The data being analyzed is looking at: 1) how often fields are actually being used (or populated with data); 2) which data tables they are associated with; and 3) the data field's positioning on the user interface. Not only does the algorithm look at the specific field name but also where in the process it is being used, as well as where the information is displayed on the interface for the user. This unique analysis will learn not only the most effective fields to recommend but precisely where the field should be in the process and where the field should display on the screen to bring the maximum value to the business. The resulting predictions transcend a simple binary response (if X, then Y), but calculate success factors based on a variety of computational factors. Scores, results, and recommendations are then stored in the usage database 50.

A flow diagram for the CRM implementation software using the prediction engine is illustrated in FIG. 3.

The CRM implementation software begins at a start node 100. A CRM implementation software business, using the business system 44, logs into their user account to begin the implementation process at a block 102. The CRM implementation software presents a series of questions to establish a baseline understanding of their company industry and size. The business answers the questions presented by CRM implementation software.

Business input will align the CRM implementation software algorithm to queue up relevant questions and recommendations for the business at a block 104 to begin the business interview process and will adapt later questions and recommendations as the implementation continues. The CRM implementation software is continually compiling responses from all other business input and implementations. As a result, the CRM implementation software can analyze real-time data across many different businesses and CRMs to instantaneously give the most accurate and precise recommendations to a business as they use the CRM implementation software tool. For example, CRM implementation software might ask a business, “Would you like to require users to enter an Amount Value before allowing the system to save and continue?” CRM implementation software, in real-time, analyzes responses to that question, presenting the business with information such as: “83% of businesses like you choose ‘yes’. Of the 17% who choose no, the most common reason for choosing ‘no’ is: They don't have any other requirements to force this validation.”

The CRM implementation software will make a recommendation to the business at a block 106. The business will respond by accepting or rejecting the CRM implementation software's recommendation at a block 108. The CRM implementation software will receive the business' response, and the algorithm will analyze their response before making any new recommendations or presenting new questions at a decision block 110. Particularly, if the business accepts the recommendation, then the feedback is recorded at a block 112 and the process continues on the recommended path. If the business rejects the recommendation, then the feedback is noted at a block 114 and the path is adjusted. From either block 112 or 114 the CRM implementation algorithm continues at a block 116. The CRM implementation software is always improving in terms of accuracy as more businesses provide their responses and as CRMs provide data updates about data usage.

At a block 118, when the algorithm has finished processing the response, then if further customizations are required, the CRM implementation software will present a new question and/or recommendation to the business on the software user interface by looping back to the block 106. The business will again review the question and recommendations and provide their response. CRM implementation software will receive the business input, and the CRM implementation software algorithm will analyze and make updates, as well make new recommendations based on the results. This interaction between the business and CRM implementation software will continue until all elements of the needed implementation have been addressed. This process will continue for as long as there are more questions to answer in the implementation process.

When all questions are answered, the implementation will be developed and prepared to be deployed into the business' CRM system 46 at a block 120.

When a CRM implementation has been deployed, then the business CRM system 46 will send actual usage data to CRM implementation software at a block 122 to continually monitor and score the effectiveness of the implementation at a block 124. For example, if it was recommended by CRM implementation software and then accepted by the business to deploy a field called “Anniversary Date,” the CRM implementation software will measure how often that field is being populated by the business. It will also measure the exact position of the field, down to the pixel, on the user interface. It will measure all other variables that are true about the implementation (such as all other fields, tables, processes, and variables related to user interface) when that field is used. Finally, it will measure where in the business process the field appears and in what data tables. In this way, the CRM implementation software is taking a three dimensional look at the effectiveness of any given field it recommends based on the field itself, where it appears on the screen, what other fields and factors are also true about the implementation, and when the field appears in the business process.

The CRM implementation software will measure and analyze all of this same information in any business CRM system 46 where this field is used. In this way, the CRM implementation software can draw conclusions about when this field is most effective, what other factors contribute to its success, and what other factors contribute to its failure. The CRM implementation software therefore improves its ability to make the right recommendations, at the right time, and for the right businesses based on all of these factors.

All of the analysis based on actual usage data is then stored at the usage database 50 and made accessible to the CRM implementation software algorithms at the block 116 to use when making recommendations to businesses.

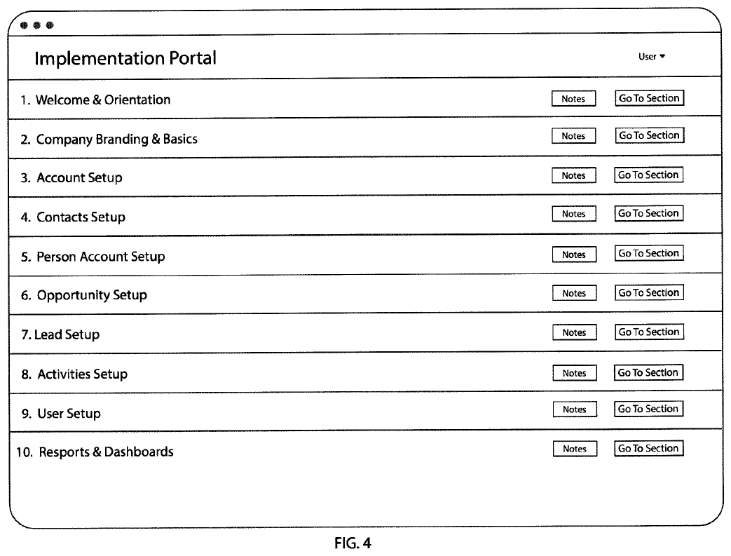

FIGS. 4-11 illustrate interactive displays presented by the software user interface on the business implementation systems 44. As will be apparent, these are representative examples as the actual screens will depend on how the business uses the setup options and the nature of the relevant business.

FIG. 4 represents the CRM implementation software user interface Implementation Portal setup screen that the business uses to select sections in which to answer questions about their business during the implementation process. This provides links to different sections where the business can provide responses for customization.

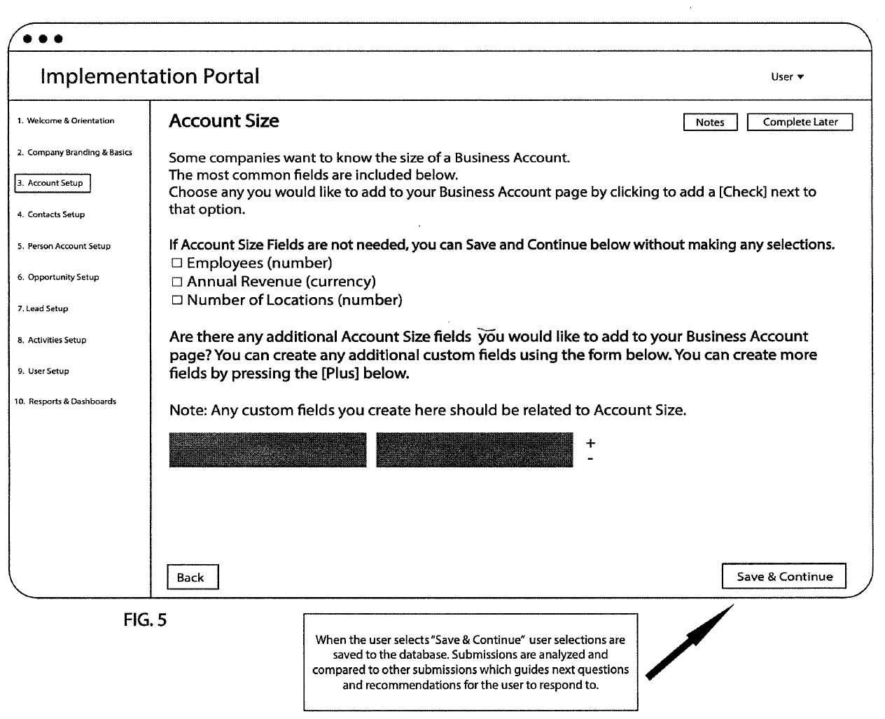

FIG. 5 represents a recommendation made by CRM implementation software on account size fields for a business to respond to on the CRM implementation software user interface. The business can select possible fields or add new fields.

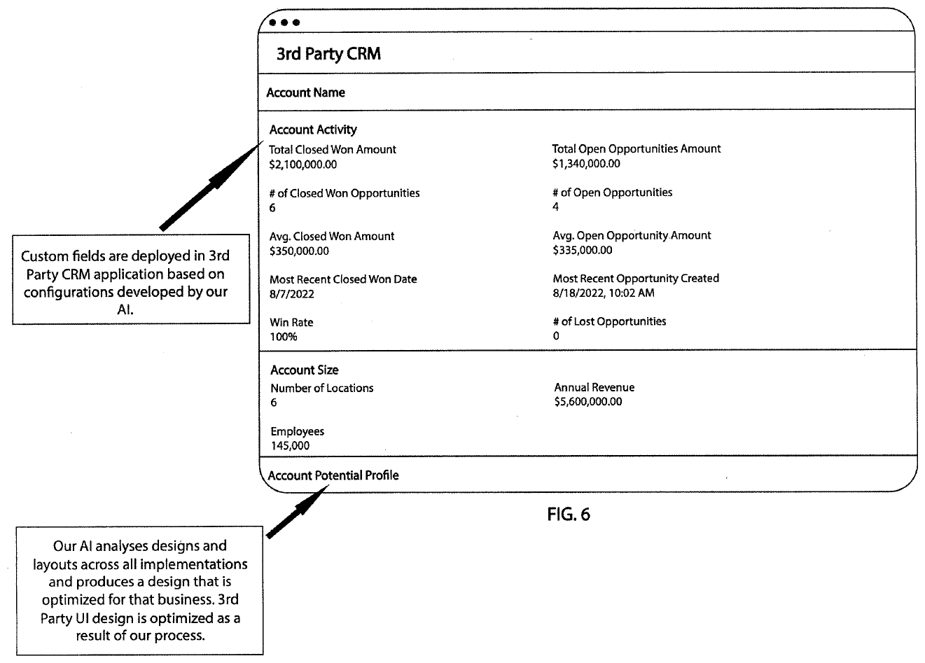

FIG. 6 illustrates a sample deployed GUI page for a 3rd Party CRM user interface. This image is displaying fields and their arrangement on the user interface based on recommendations of the CRM implementation software.

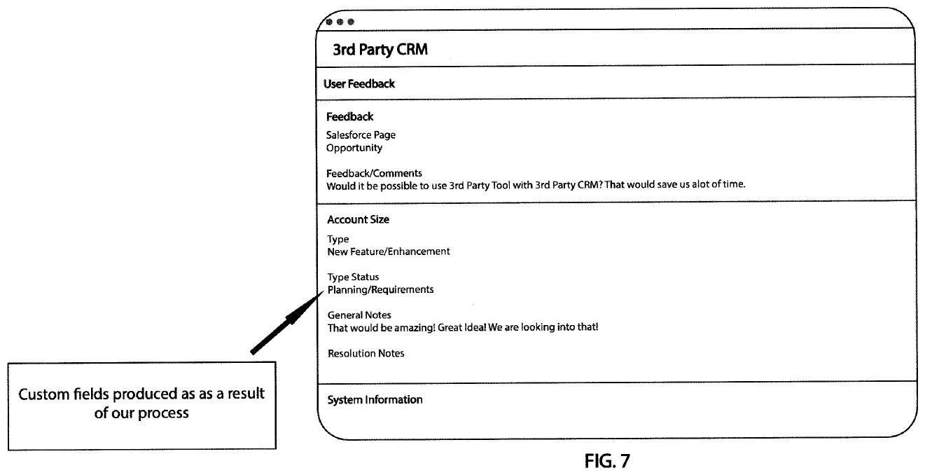

FIG. 7 represents the name and placement of a field on a 3rd party CRM user interface that was recommended by CRM implementation software.

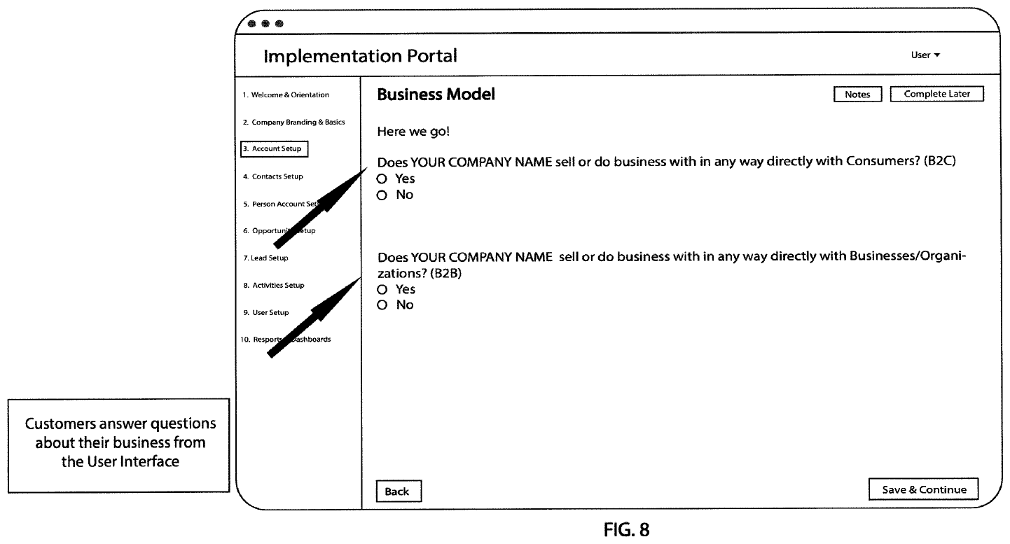

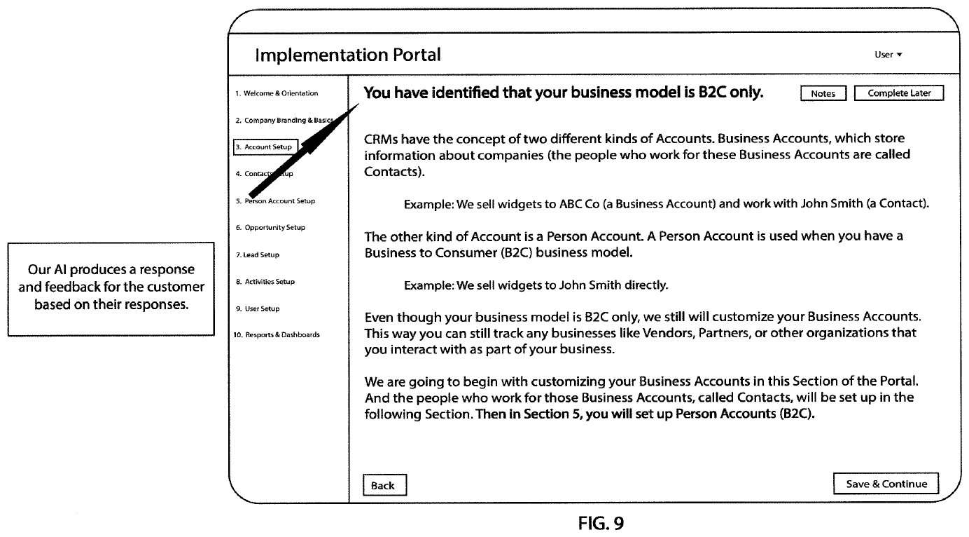

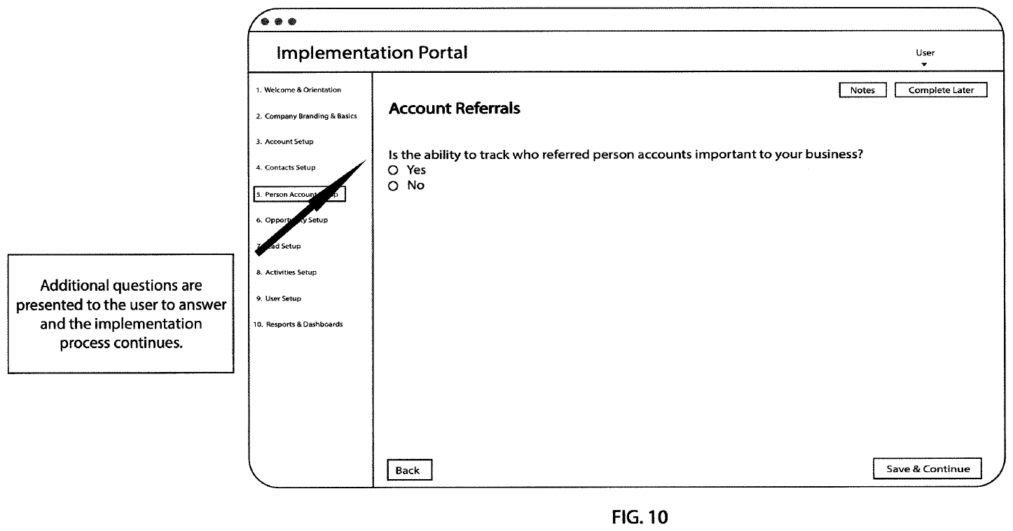

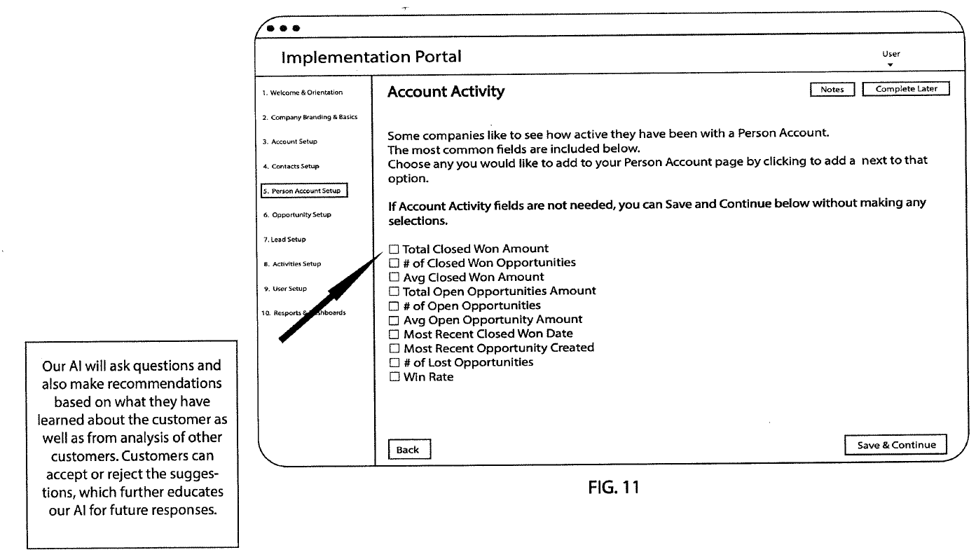

The following figures represent examples of the software user interface for data collection examples. FIG. 8 represents the CRM implementation software user interface where a business accepts or rejects recommendations made by CRM implementation software for a business model. FIG. 9 represents feedback for the business based on its responses. FIG. 10 represents additional questions presented to the business. FIG. 11 represents questions and recommendations made to the business based on what is learned from prior responses and analysis of usage data.

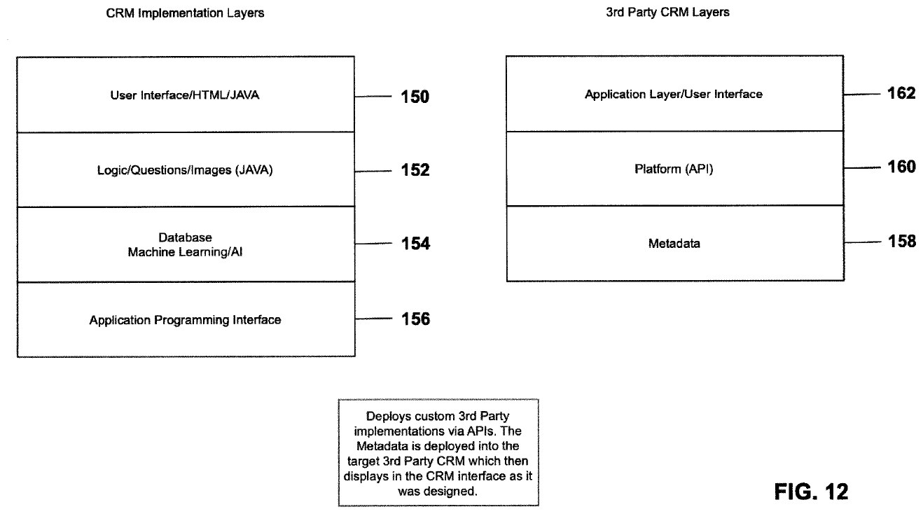

Once a customer has answered all the required questions, the CRM implementation software automatically configures the business' CRM software via APIs. FIG. 12 shows the API data layers used in the deployment process. This figure shows the various layers of software involved in CRM implementation software as well as the software layers required to integrate with 3rd party CRMs.

The CRM implementation software technology stack can be broken out into four layers. The first layer is the user interface layer 150, written in JavaScript and HTML. This represents the images and texts users see to interact with CRM implementation software in the portal/website. The second layer 152 is the framework, written in Java. This layer determines the logic and flow for the images and texts the users sees based upon their inputs, and based upon the recommendations produced as a result of these inputs. The third layer 154 is the database, written in PostgreSQL. The database is long term storage for the user's inputs for them to resume their implementation or for admins to retrieve the results of an implementation. The CRM implementation software recommends and builds solutions on third party CRM software platforms. Through the analysis of CRM implementation inputs by all customers, through the analysis of usage of CRM technologies by these customers, and through machine learning techniques, the CRM implementation software recommends and implements solutions. This third layer 154 uses artificial intelligence and machine learning to analyze very large data sets of implementations across many geographies, business sizes, industries, and other distinct criteria to make recommendations based on this analysis.

Rather than relying on a specific set of data, the system 40 is constantly monitoring and learning from new implementations of various CRM technologies. It can measure the usefulness and effectiveness of the recommendations by analyzing usage data. This architecture allows the CRM implementation software to analyze data and make predictions based on insights not available to human consultants.

The CRM implementation software continues to analyze and recommend new and valuable solutions for our customers by monitoring ongoing usage across all customer data sets as well as the individual customer's usage. These data sets are received via API and then analyzed in the CRM implementation software. This blended approach draws upon the needs and experiences of thousands of businesses across various platforms to predict success and recommend what is needed to achieve success in the future.

The fourth layer 156 is the API (Application Programming Interface). The API interacts and syncs the software package created by the CRM implementation software with any API-enabled CRM technologies (e.g. Salesforce), resulting in a customized implementation of that CRM technology. Previously existing software requires that a user interact with setup via an admin interface. The CRM implementation software bypasses the need for human interaction and decision making. Particularly, metadata 158 is deployed into the third party CRM which then via a platform layer 160 displays in the CRM software GUI interface 162 as it was designed.

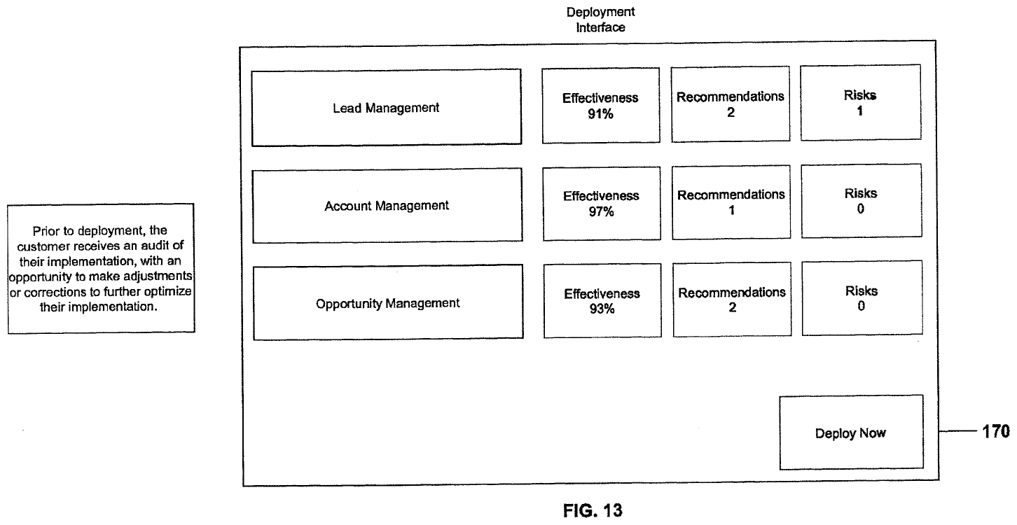

FIG. 13 illustrates a deployment interface that a business will see and review prior to the CRM implementation software developing the software package for deployment to the 3rd party CRM system 46. The business receives an audit of the implementations with an opportunity to make adjustments or corrections to further optimize the implementation. Once satisfied, the business deploys the CRM implementation software using a link 170.

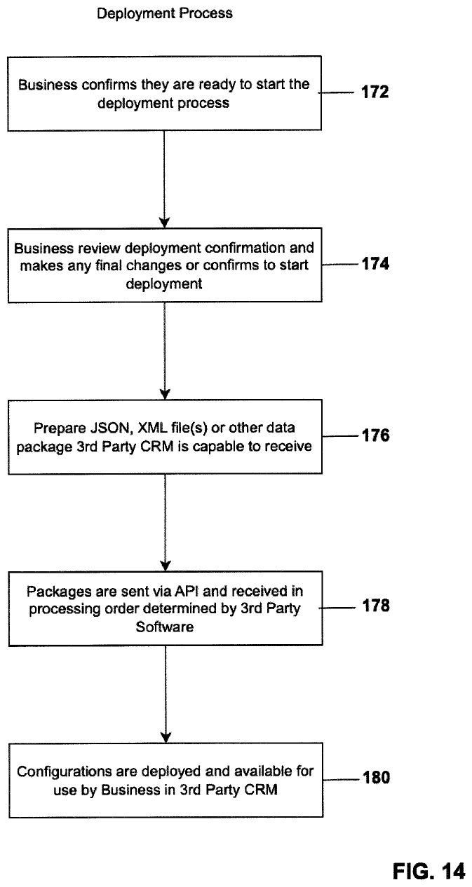

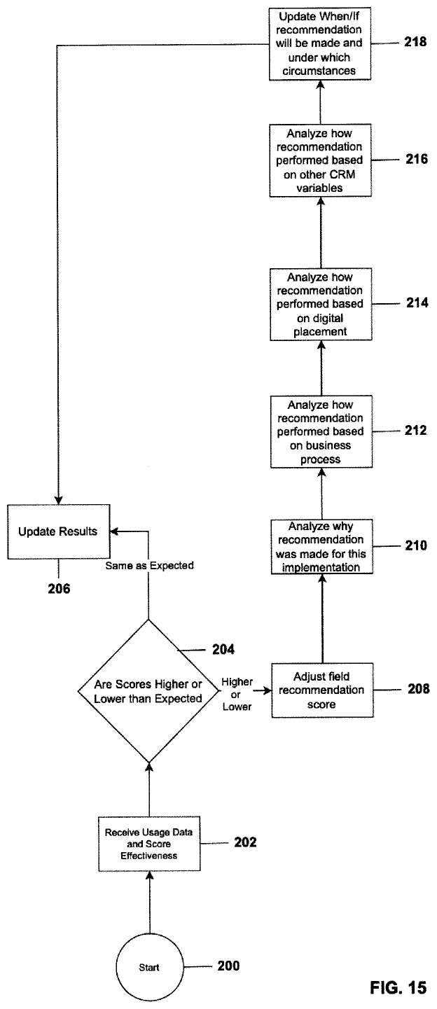

FIG. 14 illustrates the process that is followed for the CRM implementation software to develop the software that will be deployed in the 3rd party CRM system 46.

The deployment process begins when the business confirms that it is ready for deployment at a block 172. The business reviews the deployment confirmation and makes any final changes or confirms deployment as by selecting the link 170, above, in FIG. 13, at a block 174. The CRM implementation software prepares the files and/or data package for the 3rd party CRM at a block 176 and the package is sent via API at a block 178. Finally, at a block 180, the configurations are deployed for use by the business in its CRM software.

FIG. 16 is a flow chart illustrating how usage data is used to score effectiveness for future CRM implementations. The process begins at a start node 200.

Data from live CRM deployments share information about the implementation usage with CRM implementation software at a block 202. This includes what fields are being used, in what part of the business process is the field used, the digital placement of that field on the User Interface, and the combination of other CRM elements that have been deployed with that field. The statistical model will analyze how often this field is being used, such as determining if there is data in those fields, and generate an effectiveness score.

The CRM implementation software will look at whether or not the score for any field and digital placement for every single implementation is higher or lower than the expected effectiveness score at a decision block 204. If the score is the same as expected, the results will be recorded, and the overall prediction CRM implementation software gave will be reinforced at a block 206.

If the score is higher or lower, the algorithm will analyze what impacted the change. The CRM implementation software will record the new score and begin the process of understanding the factors that impacted the score at a block 208. At a block 210 the CRM implementation software studies the score to understand all the factors that impacted the score, including the name of the field itself, where in the process the field is used, digital placement on the user interface, and all other CRM variables. It will first consider what variables led to making the prediction in the first place. Next the CRM implementation software will analyze where in the business process the field was used at a block 212. How does this compare with other deployments of the same field and what were the effectiveness scores.

The CRM implementation software will then analyze the digital placement of the field on the user interface at a block 214. Particularly, the process compares the deployment with other deployments of the same field and what were the effectiveness scores. At a block 216 the CRM implementation software analyzes other CRM variables, including all other fields also deployed, where all of those fields were used in the business process, and where all of those fields were digitally displayed on the user interface. Based on this analysis, the CRM implementation software will improve its ability to make predictions in the future based on all of these particular variables at a block 218. In this phase the model will update the accuracy and precision of its predictions for future recommendations. The algorithm will also update and create new algorithms based on its learning, leading to increasingly better responses and recommendations based on the data it receives.

Updated effectiveness scores will be recorded at the block 206 for future analysis and predictions, which makes each new implementation more accurate and valuable for future CRM deployments. Based on factors that are successful across all implementations, CRM implementation software will understand what, when, and where data should be presented for businesses to maximize the implementation of their CRM.

Thus, there is disclosed herein a system and method for creating third party Customer Relationship Manager (CRM) software applications including a customized graphical user interface (GUI) to manage interactions between a business and its customers and/or prospects. The system comprises a response database system storing historical responses of businesses to questions regarding its business, fields to use in its GUI and placement of fields in the GUI. A usage database system stores actual usage data from ongoing third party CRM software applications. a software user interface operates on one or more user processing systems and is operative to present questions to a business user regarding its business, fields to use in the GUI and placement of fields in the GUI. A server system is in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields. The server system is programmed to communicate with the software user interface to present the recommendations to the business user. The server system is programmed to respond to approval of the business user to the recommendations, configuring the CRM software application comprising the customized GUI and creating Application Programming Interface (API) connections that interact and sync the customized GUI with API layers in the business users CRM software.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The foregoing disclosure of specific embodiments is intended to be illustrative of the broad concepts comprehended by the invention.

1. A computer implemented method of creating third party Customer Relationship Manager (CRM) software applications including a customized graphical user interface (GUI) to manage interactions between a business and its customers and/or prospects, the method comprising:
providing a response database system storing historical responses of businesses to questions regarding its business, fields to use in its GUI and placement of fields in the GUI;
providing a software user interface operating on one or more user processing systems which is operative to present questions to a business user regarding its business, fields to use in the GUI and placement of fields in the GUI;
providing a server system in operative communication with the response database system and the software user interface and operating CRM implementation software comprising a software prediction engine, the software prediction engine being operative to control the software user interface to present questions to the business user and to store current responses in the response database system, the software prediction engine automatically compares current responses to historical responses to recommend what fields to use in the GUI, when in the process such fields should appear and where in the GUI to display the fields;
the server system communicating with the software user interface to present the recommendations to the business user; and
responsive to approval of the business user to the recommendations, the server system configures the CRM software application comprising the customized GUI and creating Application Programming Interface (API) connections that interact and sync the customized GUI with API layers in the business users CRM software.

2. The computer implemented method of claim 1 wherein the server system controls the software user interface to presents additional questions to the business user responsive to the current responses and to store further current responses in the response database system.

3. The computer implemented method of claim 1 wherein the server system controls the software user interface to continually present additional questions to the business user until all needed questions have been responded to.

4. The computer implemented method of claim 1 wherein the software prediction engine comprises software algorithms looking for patterns and trends related to fields, business processes, and digital placement of fields on the GUI.

5. The computer implemented method of claim 1 wherein the server system is in operative communication with processing systems using business users CRM software and the server system receives actual usage data from ongoing implementations of CRM software applications to continually monitor and score the effectiveness of the implementations.

6. The computer implemented method of claim 5 further comprising a usage database system storing the actual usage data.

7. The computer implemented method of claim 6 wherein the software prediction engine is operative to automatically compares current responses to historical responses and to actual usage data to recommend what fields to use in the GUI, when in the process such fields should appear and where in the GUI to display the fields.

8. The computer implemented method of claim 6 wherein the software prediction engine continually updates questions to present to the business user responsive to actual usage data.

9. The computer implemented method of claim 6 wherein the CRM implementation software continually monitors and score effectiveness of ongoing CRM software applications to improve predictions and recommendations.

10. The computer implemented method of claim 9 wherein the CRM implementation software continually determines if scores are higher or lower than expected and updates the accuracy and precision of its predictions for future recommendations and updates and creates new algorithms based the scoring and actual usage data to improve responses and recommendations.

11. A computer implemented method of creating third party Customer Relationship Manager (CRM) software applications including a customized graphical user interface (GUI) to manage interactions between a business and its customers and/or prospects, the method comprising:
providing a response database system storing historical responses of businesses to questions regarding its business, fields to use in its GUI and placement of fields in the GUI;
providing a usage database system storing actual usage data from ongoing third party CRM software applications;
providing a software user interface operating on one or more user processing systems which is operative to present questions to a business user regarding its business, fields to use in the GUI and placement of fields in the GUI;
providing a server system in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields;
the server system communicating with the software user interface to present the recommendations to the business user; and
responsive to approval of the business user to the recommendations, the server system configures the CRM software application comprising the customized GUI and creating Application Programming Interface (API) connections that interact and sync the customized GUI with API layers in the business users CRM software.

12. The computer implemented method of claim 11 wherein the server system controls the software user interface to presents additional questions to the business user responsive to the current responses and to store further current responses in the response database system.

13. The computer implemented method of claim 11 wherein the server system controls the software user interface to continually present additional questions to the business user until all needed questions have been responded to.

14. The computer implemented method of claim 11 wherein the software prediction engine comprises software algorithms looking for patterns and trends related to fields, business processes, and digital placement of fields on the GUI.

15. The computer implemented method of claim 11 wherein the software prediction engine is operative to automatically compares current responses to historical responses and to actual usage data to recommend what fields to use in the GUI, when in the process such fields should appear and where in the GUI to display the fields.

16. The computer implemented method of claim 11 wherein the software prediction engine continually updates questions to present to the business user responsive to actual usage data.

17. The computer implemented method of claim 11 wherein the CRM implementation software continually monitors and score effectiveness of ongoing CRM software applications to improve predictions and recommendations.

18. The computer implemented method of claim 17 wherein the CRM implementation software continually determines if scores are higher or lower than expected and updates the accuracy and precision of its predictions for future recommendations and updates and creates new algorithms based the scoring and actual usage data to improve responses and recommendations.

19. A system for creating third party Customer Relationship Manager (CRM) software applications including a customized graphical user interface (GUI) to manage interactions between a business and its customers and/or prospects, comprising:
a response database system storing historical responses of businesses to questions regarding its business, fields to use in its GUI and placement of fields in the GUI;
a usage database system storing actual usage data from ongoing third party CRM software applications;
a software user interface operating on one or more user processing systems which is operative to present questions to a business user regarding its business, fields to use in the GUI and placement of fields in the GUI;
a server system in operative communication with the response database system, the actual usage database system, and the software user interface and operating CRM implementation software comprising a software prediction engine, the software prediction engine being operative to control the software user interface to present questions to the business user and to store current responses in the response database system, the software prediction engine automatically compares current responses to historical responses and actual usage data to recommend what fields to use in the GUI, when in the process such fields should appear and where in the GUI to display the fields;
the server system being programmed to communicate with the software user interface to present the recommendations to the business user; and
the server system being programmed to respond to approval of the business user to the recommendations, configuring the CRM software application comprising the customized GUI and creating Application Programming Interface (API) connections that interact and sync the customized GUI with API layers in the business users CRM software.

20. The system of claim 19 wherein the software prediction engine comprises software algorithms looking for patterns and trends related to fields, business processes, and digital placement of fields on the GUI.

21. The computer implemented method of claim 20 wherein the software prediction engine is operative to automatically compares current responses to historical responses and to actual usage data to recommend what fields to use in the GUI, when in the process such fields should appear and where in the GUI to display the fields.

22. The computer implemented method of claim 20 wherein the software prediction engine continually updates questions to present to the business user responsive to actual usage data.

23. The computer implemented method of claim 20 wherein the CRM implementation software continually monitors and score effectiveness of ongoing CRM software applications to improve predictions and recommendations.

24. The computer implemented method of claim 23 wherein the CRM implementation software continually determines if scores are higher or lower than expected and updates the accuracy and precision of its predictions for future recommendations and updates and creates new algorithms based the scoring and actual usage data to improve responses and recommendations.
